(19) United States
(12) Patent Application Publication
(10) Pub. No.: US 2024/0045257 A1
(43) Pub. Date: Feb. 8, 2024

(54) VIEWING ANGLE DIFFUSION FILM AND DISPLAY DEVICE

(71) Applicant: SHENZHEN CHINA STAR OPTOELECTRONICS SEMICONDUCTOR DISPLAY TECHNOLOGY CO., LTD., Shenzhen, Guangdong (CN)

(72) Inventors: Chengxiao Sun, Shenzhen, Guangdong (CN); Miao Zhou, Shenzhen, Guangdong (CN)

(73) Assignee: SHENZHEN CHINA STAR OPTOELECTRONICS SEMICONDUCTOR DISPLAY TECHNOLOGY CO., LTD., Shenzhen, Guangdong (CN)

(21) Appl. No.: 17/623,585

(22) PCT Filed: Dec. 24, 2021
(86) PCT No.: PCT/CN2021/141219

§ 371 Date: Jun. 22, 2023

(30) Foreign Application Priority Data
Dec. 14, 2021 (CN) 202111532059.1

(51) Int. Cl. G02F 1/1335

(52) U.S. Cl. CPC G02F 1/133504; G02F 1/133528; G02F 1/13362

(57) ABSTRACT

A viewing angle diffusion film and a display device are provided. The viewing angle diffusion film includes a substrate, a plurality of prism structures disposed on a surface of the substrate, and a dielectric layer filled between two adjacent prism structures. Each of the prism structures includes a first side surface and a second side surface, and a distance from the first side surface to the second side surface of each of the prism structures gradually decreases in a direction away from the surface of the substrate. It prevents light from diffusing in unnecessary directions, and a utilization rate of light is increased.

### CROSS REFERENCE TO RELATED APPLICATIONS

This application claims the priority of a Chinese patent application No. 202111532059.1 filed on Dec. 14, 2021 and titled “VIEWING ANGLE DIFFUSION FILM AND DISPLAY DEVICE”, which is incorporated herein by reference in its entirety.

### FIELD OF DISCLOSURE

The present disclosure relates to the field of display technologies, in particular to a viewing angle diffusion film and a display device.

### BACKGROUND

Applications of liquid crystal displays in daily life are very common. The liquid crystal display usually takes a direction perpendicular to a screen as a front view direction. When designing and manufacturing liquid crystal display screen, a main guarantee is a brightness of the front view direction. Therefore, when a viewing angle direction of a user deviates from the front view direction, a display effect of the liquid crystal display is not good, which not only has low brightness, but also has a problem of color shift.

In order to solve the above problems, an industry usually adds a diffusion film to the liquid crystal display to improve performance of the liquid crystal display in a non-front view direction. However, the existing diffusion film has basically a same light diffusion ability in all directions, and light diffusion in unnecessary directions will result in a waste of light energy.

Therefore, the existing technology has defects and needs to be improved and developed.

### SUMMARY OF DISCLOSURE

The present disclosure provides a viewing angle diffusion film, which aims to prevent the viewing angle diffusion film from diffusing light in unnecessary directions.

An embodiment of the present disclosure provides a viewing angle diffusion film, including a substrate, a plurality of prism structures disposed on a surface of the substrate, and a dielectric layer filled between two adjacent prism structures. Each of the prism structures comprises a first side surface and a second side surface, and a distance from the first side surface to the second side surface of each of the prism structures gradually decreases in a direction away from the surface of the substrate.

In some embodiments of the present disclosure, the plurality of prism structures are arranged on the surface of the substrate along a first direction at a predetermined distance.

In some embodiments of the present disclosure, the prism structure comprises a first sub-prism and a second sub-prism connected to each other along the first direction, and the first side surface of the first sub-prism is not parallel to the first side surface of the second sub-prism.

In some embodiments of the present disclosure, the predetermined distance ranges from 0-50 μm.

In some embodiments of the present disclosure, a height of the prism structure ranges from 1 to 20 μm.

In some embodiments of the present disclosure, a refractive index of the prism structure ranges from 1.5 to 2.5.

In some embodiments of the present disclosure, a cross-sectional shape of the prism structure in a thickness direction of the substrate comprises at least one of a triangle and a trapezoid.

In some embodiments of the present disclosure, the viewing angle diffusion film further comprises a protective layer disposed on the plurality of prism structures and the dielectric layer.

In some embodiments of the present disclosure, the plurality of prism structures are formed on the surface of the substrate by imprinting.

In some embodiments of the present disclosure, the prism structures comprise reactive particles.

In some embodiments of the present disclosure, a refractive index of the prism structures is greater than a refractive index of the dielectric layer.

The present disclosure also provides a display device, including the viewing angle diffusion film as mentioned above.

The present disclosure also provides another display device, comprising: a backlight module; a lower polarizer disposed on the backlight module; a liquid crystal display panel disposed on the lower polarizer; an upper polarizer disposed on the liquid crystal display panel; a plurality of prism structures disposed on a surface of the upper polarizer, and a dielectric layer filled between two adjacent prism structures. Each of the prism structures comprises a first side surface and a second side surface, and a distance from the first side surface to the second side surface of each of the prism structures gradually decreases in a direction away from the surface of the substrate.

The present disclosure provides the viewing angle diffusion film and the display device, the prism structures are disposed on the surface of the substrate. When parallel light beams incident from the surface of the substrate into the prism structures are refracted into the dielectric layer through the first side surface or the second side surface, the light beams are still parallel. Moreover, the distance from the first side surface to the second side surface gradually decreases in the direction away from the substrate. Therefore, by controlling the longest and shortest distances from the first side surface to the second side surface, a direction of light refraction of the viewing angle diffusion film is defined. Therefore, it is realized that the light can be diffused in a selective direction, and the light is prevented from being diffused in the unnecessary direction, thereby improving a utilization rate of the light.

### BRIEF DESCRIPTION OF DRAWINGS

FIG. 1 is a schematic diagram of a cross-sectional structure of a viewing angle diffusion film of an embodiment of the present disclosure.

FIG. 2 is a schematic structural diagram of a combination of a plurality of prism structures and a substrate of an embodiment of the present disclosure.

FIG. 3A to FIG. 3C are cross-sectional views of a plurality of prism structures of an embodiment of the present disclosure.

FIG. 4A to FIG. 4C are top views of a plurality of prism structures of an embodiment of the present disclosure.

FIG. 5 is a normalized brightness at different viewing angles.

FIG. 6 is a cross-sectional view of another viewing angle diffusion film according to an embodiment of the present disclosure.

FIG. 7 is a schematic structural diagram of a display device of an embodiment of the present disclosure.

FIG. 8 is a schematic structural diagram of another display device of an embodiment of the present disclosure.

### DETAILED DESCRIPTION

The technical solutions in the embodiments of the present disclosure will be clearly and completely described below in conjunction with the drawings in the embodiments of the present disclosure. Apparently, the described embodiments are only a part of the embodiments of the present disclosure, rather than all the embodiments. Based on the embodiments in the present disclosure, all other embodiments obtained by those skilled in the art without creative efforts shall fall within the scope of protection of the present disclosure.

In the description of the present disclosure, it should be understood that directions or location relationships indicated by terms “center”, “longitudinal”, “transverse”, “length”, “width”, “thickness”, “upper”, “lower”, “front”, “rear”, “left”, “right”, “vertical”, “horizontal”, “top”, “bottom”, “inner”, “outer”, “clockwise”, and “counterclockwise” are directions or location relationships shown based on the accompanying drawings, are merely used for the convenience of describing the present disclosure and simplifying the description, but are not used to indicate or imply that a device or an element must have a particular direction or must be constructed and operated in a particular direction, and therefore, cannot be understood as a limitation to the present disclosure. In addition, terms “first” and “second” are merely used to describe the objective, but cannot be understood as indicating or implying relative importance or implying a quantity of indicated technical features. Therefore, features limited by “first” and “second” may indicate explicitly or implicitly that one or more features are included. In the description of the present disclosure, unless otherwise specifically limited, “multiple” means at least two.

In the present disclosure, unless otherwise clearly stipulated and limited, terms “mount”, “connect”, and “fix” should be understood in a generalized manner, for example, may be understood as fixed connection, detachable connection, or integration; or may be understood as mechanical connection, electrical connection, or mutual communication; or may be understood as direct connection, or indirect connection with a medium, or internal communication of two elements or a mutual relationship between two elements. A person of ordinary skill in the art may understand specific meanings of the terms in the present disclosure according to specific situations.

In the present disclosure, unless otherwise clearly stipulated and limited, that a first feature is “above” or “below” a second feature may include that the first feature directly contacts the second feature, or may include that the first feature does not contact the second feature directly but contacts the second feature with another feature between them. In addition, that the first feature is “above” the second feature includes that the first feature is right above the second feature and is not right above the second feature, or merely represents that a horizontal height of the first feature is higher than the second feature. That the first feature is “below” the second feature includes that the first feature is right below the second feature and is not right below the second feature, or merely represents that a horizontal height of the first feature is lower than the second feature.

The disclosure of the following description provides many different embodiments or examples for realizing different structures of the present application. In order to simplify the disclosure of the present application, described below are components and settings of specific examples. Of course, they are only examples, and are not aimed at limiting the present application. Moreover, the present application can repeat reference numbers and/or reference letters in different examples, but such repetition is for the sake of simplification and clearness, and it does not indicate the relation between various embodiments and/or settings discussed. Furthermore, the present application provides the examples of various specific processes and materials, but the ordinary skilled persons in the art could conceive of application of other processes and/or usage of other materials.

In addition to the foregoing implementation, the present disclosure may also have other implementations. All technical solutions formed by equivalent replacements or equivalent replacements fall within the scope of protection of the present disclosure.

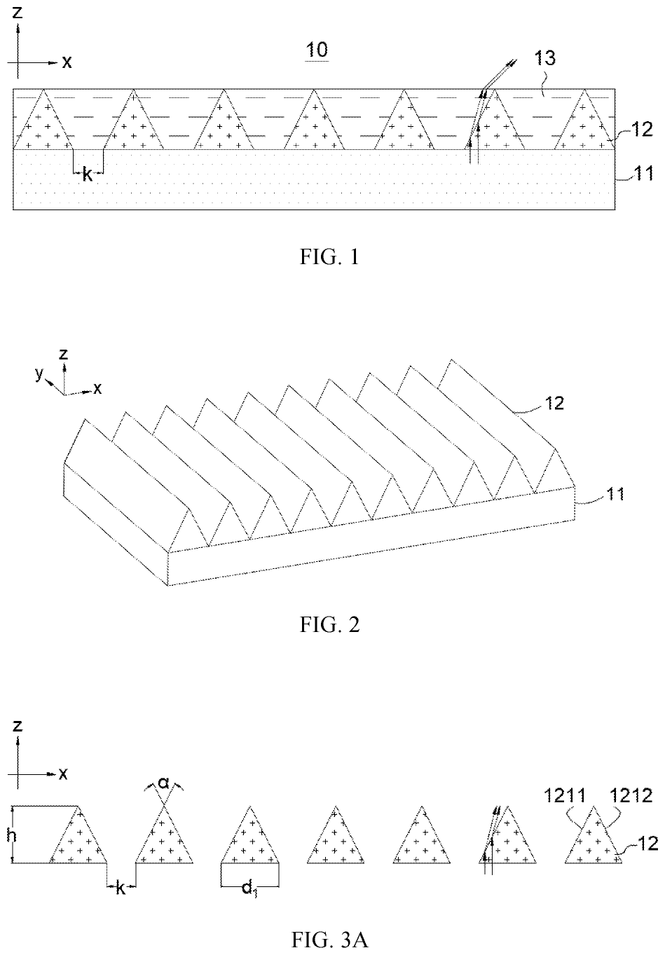

Referring to FIG. 1, which is a schematic structural diagram of a viewing angle diffusion film of an embodiment of the present disclosure. In FIG. 1, the first direction may be an x direction. A thickness direction may be a z direction, and the z direction corresponds to a front view direction of a user. The viewing angle diffusion film 10 includes a substrate 11, a plurality of prism structures 12, and a dielectric layer 13. The plurality of the prism structures 12 are disposed on the substrate 11. The dielectric layer 13 is disposed between two adjacent prism structures 12.

Specifically, a transparent polymer can be selected for the substrate 11, so that light entering the substrate 11 can be emitted from a surface of the substrate 11. In this embodiment, material of the substrate 11 may include polyethylene terephthalate (PET), polymethyl methacrylate (PMMA), and polystyrene (PS).

Transparent polymers can also be selected for the prism structures 12, and specific materials can include PMMA, PS, and epoxy. In addition, according to a requirement of increasing a refractive index of the prism structures 12, refractive particles are alternatively added into the prism structures 12, such as BaTiO3, TiO2, ZrO2, etc., to increase a refractive index of inorganic particles to enhance a light modulation ability of the prism structures 12. The refractive index of the prism structures 12 can be adjusted by adjusting a content or ratio of the above-mentioned inorganic particles. A preferred range of the refractive index of the prism structures 12 is 1.5-2.5.

Referring to FIG. 1 and FIG. 2, FIG. 2 is a schematic diagram of a combined of the prism structures 12 and the substrate 11. It should be noted that, in this embodiment, the plurality of prism structures 12 are preferably formed on the substrate 11 an imprinting process. A pattern on a template (not shown in the figure) is transferred to the substrate 11 to form the plurality of prism structures 12 by means of mechanical transfer along the z direction in FIG. 1 and FIG. 2.

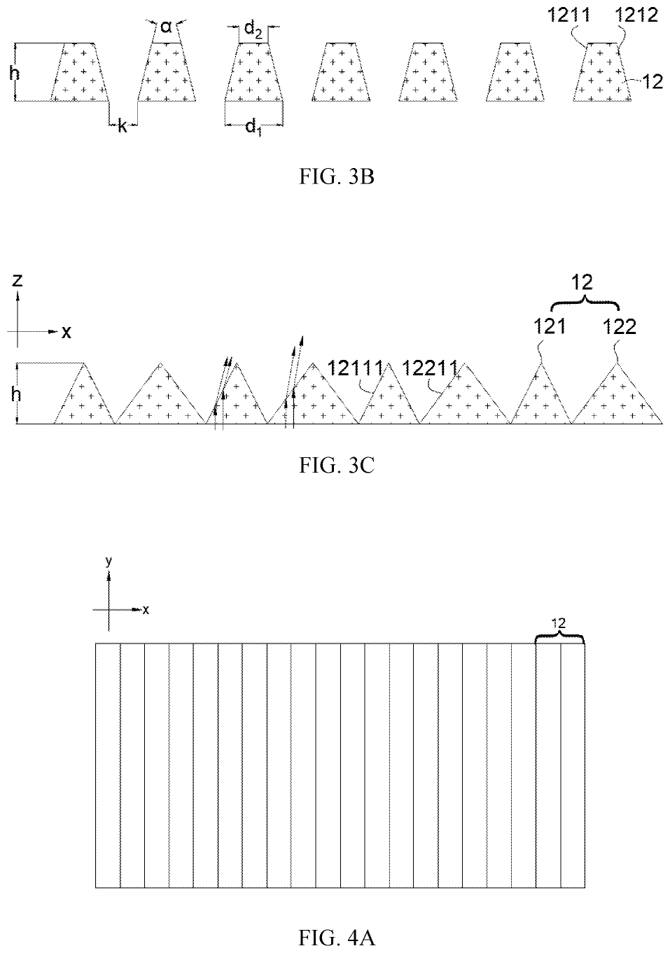

Referring to FIG. 3A to FIG. 3C, which show three cross-sectional views of the plurality of prism structures 12. The prism structure 12 includes a first side surface 1211 and a second side surface 1212. The first side surface 1211 and the second side surface 1212 are continuously approaching along the z direction. It is understandable that when the plurality of prism structures 12 are disposed on the substrate 11, a distance from the first side surface 1211 to the second side surface 1212 is continuously reduced in a direction away from the surface of the substrate 11. It should be further explained that since the first side surface 1211 and the second side surface 1212 are part surface of the prism structure 12, the first side surface 1211 and/or the second side surface 1212 are planar structures. As shown in FIG. 3A, when multiple parallel beams of light are emitted from the prism structures 12, each beam of light remains parallel.

In this embodiment, in order to achieve a corresponding refraction effect, a cross-sectional shape of the prism structure 12 is also designed. For example, in FIG. 3A, the cross-sectional shape of the prism structure 12 in the z direction is triangular. Theus, the farthest distance from the first side surface 1211 to the second side surface 1212 is d1 (d1>0). The shortest distance between the first side surface 1211 and the second side surface 1212 is 0. In FIG. 3B, the cross-sectional shape of the prism structure 12 in the z direction is trapezoid. Thus, the farthest distance from the first side surface 1211 to the second side surface 1212 is d1 (d1>d2). The shortest distance between the first side surface 1211 and the second side surface 1212 is d2 (d2>0). In FIG. 3C, the cross-sectional shape of the prism structure 12 in the z direction can also be a combination of two different triangles. In other embodiments, the cross-sectional shape of the prism structure 12 may also be irregular polygons or a combination of triangles and trapezoids.

It is understandable that the first side surface 1211 and the second side surface 1212 are continuously approaching along the z direction, so that after determining a height of prism structure, an angle between the first side surface 1211 and the second side surface 1212 can be defined by defining the farthest distance as d1 and d2. Furthermore, the height h of the prism structure 12 is preferably in a range of 1-20 μm, and the angle formed by the first side surface 1211 and the second side surface 1212 is in a range of 20° to 160°.

Referring to FIG. 1, the plurality of prism structures 12 are arranged on the surface of the substrate 11 along the x direction at a predetermined distance k.

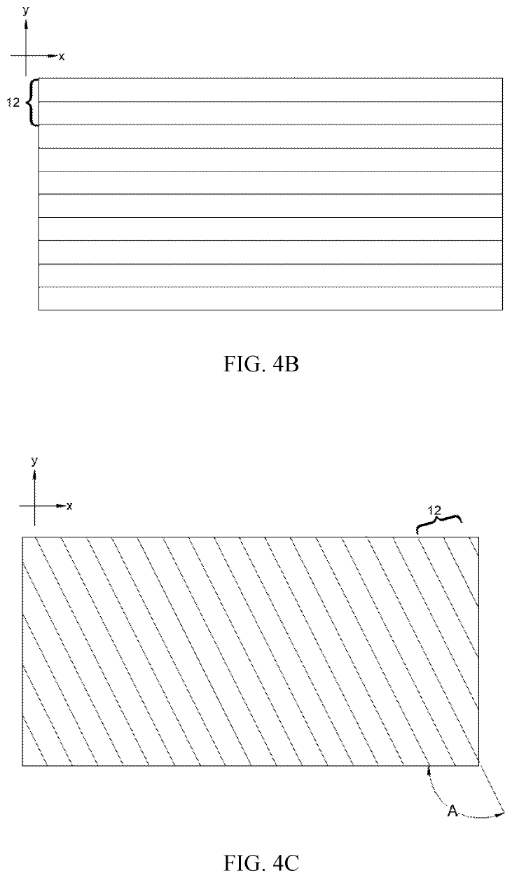

The plurality of prism structures 12 can be arranged on the surface of the substrate 11 in a certain arrangement direction according to actual needs. FIG. 4A to 4C show arrangement directions of the plurality of prism structures that can be selected. As shown in FIG. 4A, the arrangement direction of the prism structures 12 can be parallel to the x direction where a long side of the substrate 11 is located. As shown in FIG. 4B, the arrangement direction of the prism structures 12 can be perpendicular to the x direction where the long side of the substrate 11 is located. As shown in FIG. 4C, the arrangement direction of the prism structures 12 can form a certain angle A (0<A<90°) with the x direction where the long side of the substrate 11 is located. The direction of the long side of the substrate 11 also corresponds to a long side of the display device, and structural features of the display device is that an area from the outermost edge from a display center is left and right edges along the x direction instead of upper and lower edges along the y direction. Thus, in use, corresponding larger viewing angle directions are generally distributed along the x direction (the user generally watches in the x direction from left to right to see edges of the screen). Accordingly, in this embodiment, it is preferable to arrange the plurality of prism structures 12 on the surface of substrate 11 along the x direction. According to structural characteristics of the display device, the light emitted from the first side surface 1211 and the second side surface 1212 of the prism structure 12 is modulated to be distributed along the x direction. The light can be diffused in selective directions to avoid modulating the light to be distributed along the y direction, causing light loss.

It needs to be further explained that the predetermined distance k between the plurality of prism structures 12 is also designed in this embodiment. It is easy to understand that when a length of the long side of the substrate 11 and the farthest distance d1 are determined, and when k is greater than 0, the light emitted from gaps along the z direction will not be incident on the prism structures 12, and this part of the light can ensure the brightness in the front view direction. Therefore, when the number of the prism structures 12 is smaller, the light diffusion effect is weakened, and the brightness in the front view direction is higher. When a value of k is smaller (k is less than or equal to 0), the more the number of the prism structures 12, the stronger the light diffusion effect, and the lower the brightness in the front view direction. Therefore, in this embodiment, the value of the predetermined distance k can be adjusted through comprehensive needs of the diffusion effect and the brightness in the front view. A range of the predetermined distance k is preferably 0-50 μm.

Referring to FIG. 3C, the prism structure 12 may also includes a first sub-prism 121 and a second sub-prism 122 connected to each other along the x direction, and a first side surface 12111 of the first sub-prism 121 is not parallel to a first side surface 12211 of the second sub-prism 122.

Under the condition that the first side surface 12111 of the first sub-prism 121 is not parallel to the first side surface 12211 of the second sub-prism 122, when two parallel light beams are emitted from the first side surface 12111 of the first sub-prism 121 and the first side surface 12211 of the second sub-prism 122, the two light beams cannot be kept parallel. Therefore, by combining the first sub-prism 121 and the second sub-prism 122 with different cross-sectional shapes, there can be multiple modulation angles for the light diffusion, so that the light angles distributed along the x direction are more balanced.

It should be noted that a refractive index of the dielectric layer 13 is smaller than a refractive index of the prism structures 12. A range of the refractive index of the dielectric layer 13 is 1-1.5. The specific material can be a glue layer with a refractive index in the above range.

Since the dielectric layer 13 is arranged between two adjacent prism structures 12, the light emitted from the first side surface 1211 or the second side surface 1212 will be injected into the outside air after being refracted by the dielectric layer 13. Taking the parallel light beams incident on the prism structures 12 along the z direction as an example for description, when the parallel light beams are emitted from the prism structures 12, they will be refracted for a first time at an interface between the prism structures 12 and the dielectric layer 13. Since the refractive index of the dielectric layer 13 is smaller than the refractive index of the prism structures 12, an exit angle at this time is greater than an initial incident angle. When light is emitted from the dielectric layer 13 into the outside air, it will be refracted for a second time on the surface of the dielectric layer 13. Therefore, the final exit angle is further larger than the initial incident angle, so that the light incident along the z direction is modulated to a larger viewing angle direction that deviates from the z direction and is distributed along the x direction.

Due to the refraction of the prism structures 12 and the dielectric layer 13, a part of light in the front viewing angle (z direction shown in FIG. 1) is emitted at a larger viewing angle, and a part of light in larger viewing angle (not shown in FIG. 1) is emitted at a smaller viewing angle, to achieve the effect of balancing light from various viewing angles. The light of a larger viewing angle is closer to the light of the front viewing angle, thereby reducing the difference in brightness and chromaticity of different viewing angles.

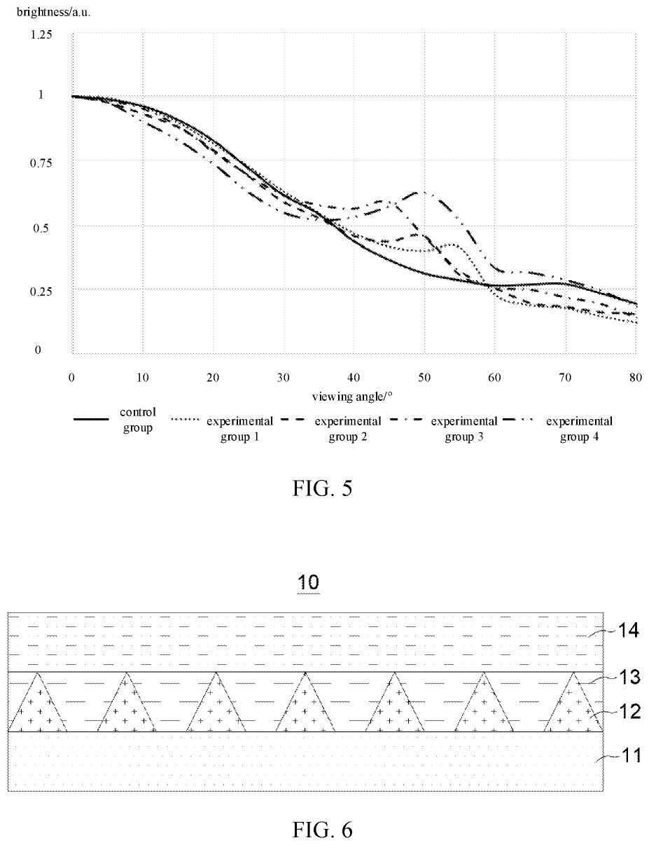

In order to verify the performance of the viewing angle diffusion film 10, the inventor of the present application also performed an optical simulation verification on the viewing angle diffusion film 10, and calculated a result of the output light of the viewing angle diffusion film 10 with different prism structures 12. Specific structure parameters are shown in Table 1. Taking a display device without the viewing angle diffusion film 10 as a control group, the viewing angle diffusion films 10 with four different prism structures 12 are designed as experimental groups, and the calculated output light results are shown in FIG. 5. The brightness is normalized. The ½ brightness viewing angle is defined as: the brightness viewing angle is a maximum viewing angle when the brightness of a center of the screen of the display device is reduced to ½.

TABLE 1

| | prism structure design | | | | |
|---|---|---|---|---|---|
| | | | | refractive | ½ brightness |
| sample | h/um | α/° | k/um | index | viewing angle/° |
| control group | — | — | — | — | 37.0 |
| experimental group 1 | 10 | 90 | 10 | 1.7 | 38.0 |
| experimental group 2 | 10 | 60 | 10 | 1.7 | 36.9 |
| experimental group 3 | 10 | 40 | 10 | 1.7 | 48.5 |
| experimental group 4 | 10 | 40 | 0 | 1.65 | 55.5 |

Referring to FIG. 5, an ordinate corresponds to a normalized brightness, that is, the display brightness of the display panel under different viewing angles, and an abscissa corresponds to the viewing angle. It can be seen from FIG. 5 that under the same light source, compared with the control group, the display device adopting the viewing angle diffusion film 10 in this application has a better brightness of a larger viewing angle.

Referring to FIG. 6, the viewing angle diffusion film 10 further includes a protective layer 14 disposed on the plurality of prism structures 12 and the dielectric layer 13.

The protective layer 14 is used to protect the plurality of prism structures 12. The protective layer 14 can be selected as a polymer coating, and can be selected as a transparent material. An anti-scratch coating or anti-glare treatment can be added to a surface of the protective layer 14.

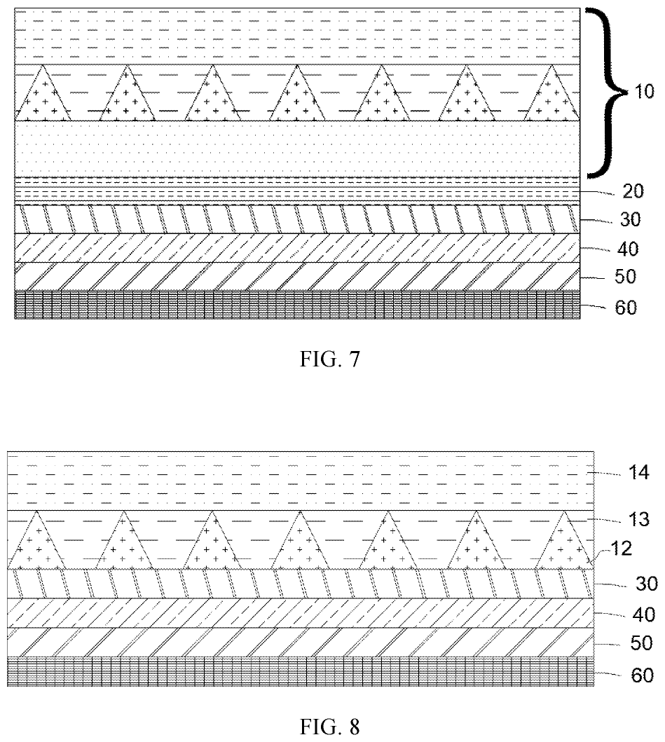

Based on the above-mentioned viewing angle diffusion film 10, referring to FIG. 7, the present disclosure also provides a display device, including the above-mentioned viewing angle diffusion film 10.

Specifically, the display device further includes a backlight module 60, a lower polarizer 50, a liquid crystal display panel 40, an upper polarizer 30, and an adhesive layer 20. The lower polarizer 50, the liquid crystal display panel 40, the upper polarizer 30, and the adhesive layer 20 are sequentially stacked on the backlight module 60. The viewing angle diffusion film 10 of this embodiment is fixedly connected to the upper polarizer 30 through the adhesive layer 20. The viewing angle diffusion film 10 is disposed on a light exit side of the upper polarizer 30.

Material of the adhesive layer 20 can be specifically selected as one or more of heat sensitive adhesive, pressure sensitive adhesive, and UV glue.

It should be noted that when the viewing angle diffusion film 10 is attached to the upper polarizer 30, the viewing angle diffusion film 10 has a light scattering effect. At this time, there is no need to add a scattering film in the backlight module 30, so as to reduce a production cost.

Based on the above-mentioned dielectric layer 13 and the plurality of prism structures 12, the present disclosure also provides another display device. As shown in FIG. 8, the display device includes a backlight module 60, a lower polarizer 50 disposed on the backlight module 60, a liquid crystal display panel 40 disposed on the lower polarizer 50, an upper polarizer 30 disposed on the liquid crystal display panel, a plurality of prism structures 12 disposed on a surface of the upper polarizer 30, and a dielectric layer 13 filled between two adjacent prism structures 12.

The plurality of prism structures 12 are formed on the surface of the upper polarizer 30 by imprinting. A pattern on a template (not shown in the figure) is transferred to the substrate 11 to form the plurality of prism structures 12 by means of mechanical transfer, using a surface of the upper polarizer 30 as a substrate surface. Therefore, in comparison with the display device in FIG. 7, the display device in FIG. 8 can reduce the substrate layer material and the adhesive layer material.

The backlight module 60 includes a back plate, an optical film, a light guide plate, and a reflective film (not shown in the figure). A plurality of light guide points are also arranged on a side of the light guide plate. The light will diffuse at all angles along the light guide points, so that the light guide plate can become a surface light source with uniform light emission. The reflective film reflects the light leaking from the light guide plate to the surface of the reflective film back to the light guide plate, thereby achieving a purpose of reducing light loss and improving light utilization. The function of the optical film is to optically shape the light emitted from the light guide plate. The optical film optically shapes the light emitted from the light guide plate.

Both the upper polarizer 30 and the lower polarizer 50 are used to control the polarization direction of a specific beam. The lower polarizer 50 is used to convert the light beam generated by the backlight module 60 into polarized light, and the upper polarizer 30 is used to analyze the polarized light modulated by the liquid crystal display panel 40 to generate a contrast between light and dark, thereby generating a display image.

Referring to FIGS. 3A to 3C, each of the prism structures 12 includes the first side surface 1211 and the second side surface 1212. As shown in FIG. 1, the distance from the first side surface 1211 to the second side surface 1212 of each prism structures 12 gradually decreases in a direction away from the surface of the substrate (i.e., the z direction).

It should be further explained that since the first side surface 1211 and the second side surface 1212 are part surface of the prism structure 12, the first side surface 1211 and/or the second side surface 1212 are planar structures. As shown in FIG. 3A, when multiple parallel beams of light are emitted from the prism structures 12, each beam of light remains parallel.

Since the dielectric layer 13 is arranged between two adjacent prism structures 12, the light emitted from the first side surface 1211 or the second side surface 1212 will be injected into the outside air after being refracted by the dielectric layer 13. Taking the parallel light beams incident on the prism structures 12 along the z direction as an example for description, when the parallel light beams are emitted from the prism structures 12, they will be refracted for a first time at an interface between the prism structures 12 and the dielectric layer 13. In this embodiment, since the refractive index of the dielectric layer 13 is smaller than the refractive index of the prism structures 12, an exit angle at this time is greater than an initial incident angle. When light is emitted from the dielectric layer 13 into the outside air, it will be refracted for a second time on the surface of the dielectric layer 13. Therefore, the final exit angle is further larger than the initial incident angle, so that the light incident along the z direction is modulated to a larger viewing angle direction that deviates from the z direction and is distributed along the x direction. Thus, the light can be diffused in selective directions.

It is understandable that since the first side surface 1211 and the second side surface 1212 are continuously approaching along the z direction, after determining a height of the prism structure 12, the angle between the first side surface 1211 and the second side surface 1212 can be defined by defining the farthest distance as d1 and d2. Thus, the direction of refraction of the viewing angle diffusion film to the light is defined, so as to ensure the brightness of the display device under a larger viewing angle, and it can also prevent the light from diffusing in the unnecessary direction.

Advantages of the present disclosure are that the present disclosure provides the viewing angle diffusion film and the display device, the prism structures are disposed on the surface of the substrate. When parallel light beams incident from the surface of the substrate into the prism structures are refracted into the dielectric layer through the first side surface or the second side surface, the light beams are still parallel. Moreover, the distance from the first side surface to the second side surface gradually decreases in the direction away from the substrate. Therefore, by controlling the longest and shortest distances from the first side surface to the second side surface, a direction of light refraction of the viewing angle diffusion film is defined. Therefore, the light can be diffused in a selective direction. It can not only ensure the brightness of the display device under a larger viewing angle, but also prevent the light from being diffused in the unnecessary direction, which improves the utilization rate of the light.

In summary, although the present disclosure has disclosed the preferred embodiments as above, the above-mentioned preferred embodiments are not intended to limit the present disclosure. Those of ordinary skill in the art can make various changes and modifications without departing from the spirit and scope of the present disclosure. Therefore, the protection scope of the present disclosure is subject to the scope defined by the claims.

What is claimed is:

1. A viewing angle diffusion film, comprising a substrate, a plurality of prism structures disposed on a surface of the substrate, and a dielectric layer filled between two adjacent prism structures,
wherein each of the prism structures comprises a first side surface and a second side surface, and a distance from the first side surface to the second side surface of each of the prism structures gradually decreases in a direction away from the surface of the substrate.

2. The viewing angle diffusion film according to claim 1, wherein the plurality of prism structures are arranged on the surface of the substrate along a first direction at a predetermined distance.

3. The viewing angle diffusion film according to claim 2, wherein the prism structure comprises a first sub-prism and a second sub-prism connected to each other along the first direction, and the first side surface of the first sub-prism is not parallel to the first side surface of the second sub-prism.

4. The viewing angle diffusion film according to claim 2, wherein the predetermined distance ranges from 0-50 μm.

5. The viewing angle diffusion film according to claim 1, wherein a height of the prism structure ranges from 1 to 20 μm.

6. The viewing angle diffusion film according to claim 1, wherein a refractive index of the prism structure ranges from 1.5 to 2.5.

7. The viewing angle diffusion film according to claim 1, wherein a cross-sectional shape of the prism structure in a thickness direction of the substrate comprises at least one of a triangle and a trapezoid.

8. The viewing angle diffusion film according to claim 1, further comprising a protective layer disposed on the plurality of prism structures and the dielectric layer.

9. The viewing angle diffusion film according to claim 1, wherein the plurality of prism structures are formed on the surface of the substrate by imprinting.

10. The viewing angle diffusion film according to claim 1, wherein the prism structures comprise reactive particles.

11. The viewing angle diffusion film according to claim 1, wherein a refractive index of the prism structures is greater than a refractive index of the dielectric layer.

12. A display device, comprising the viewing angle diffusion film according to claim 1, wherein the viewing angle diffusion film comprises a substrate, a plurality of prism structures disposed on a surface of the substrate, and a dielectric layer filled between two adjacent prism structures,
wherein each of the prism structures comprises a first side surface and a second side surface, and a distance from the first side surface to the second side surface of each of the prism structures gradually decreases in a direction away from the surface of the substrate.

13. The display device according to claim 12, wherein the plurality of prism structures are arranged on the surface of the substrate along a first direction at a predetermined distance.

14. The display device according to claim 13, wherein the prism structure comprises a first sub-prism and a second sub-prism connected to each other along the first direction, and the first side surface of the first sub-prism is not parallel to the first side surface of the second sub-prism.

15. The display device according to claim 12, wherein a cross-sectional shape of the prism structure in a thickness direction of the substrate comprises at least one of a triangle and a trapezoid.

16. The display device according to claim 12, the viewing angle diffusion film further comprises a protective layer disposed on the plurality of prism structures and the dielectric layer.

17. The display device according to claim 12, wherein the plurality of prism structures are formed on the surface of the substrate by imprinting.

18. The display device according to claim 12, wherein the prism structures comprise reactive particles.

19. The display device according to claim 12, wherein a refractive index of the prism structures is greater than a refractive index of the dielectric layer.

20. A display device, comprising:
a backlight module;
a lower polarizer disposed on the backlight module;
a liquid crystal display panel disposed on the lower polarizer;
an upper polarizer disposed on the liquid crystal display panel;
a plurality of prism structures disposed on a surface of the upper polarizer, and a dielectric layer filled between two adjacent prism structures;
wherein each of the prism structures comprises a first side surface and a second side surface, and a distance from the first side surface to the second side surface of each of the prism structures gradually decreases in a direction away from the surface of the substrate.
